(19) United States
(12) Patent Application Publication
(10) Pub. No.: US 2017/0066120 A1
(43) Pub. Date: Mar. 9, 2017

(54) HAND TOOL ASSEMBLY

(71) Applicant: Man-Chi Chang, Taichung (TW)

(72) Inventor: Man-Chi Chang, Taichung (TW)

(21) Appl. No.: 14/844,012

(22) Filed: Sep. 3, 2015

(51) Int. Cl. B25G 1/06; B25B 23/16; B25B 23/00

(52) U.S. Cl. CPC B25G 1/063; B25B 23/0035; B25B 23/16

(57) ABSTRACT

A hand tool assembly includes a rod and a handle which is pivotably connected to the rod, and a control unit which is movable along the rod. When the rod and the handle are located linearly, the control unit is moved to a position where the rod and the handle are secured linearly. When the handle is perpendicular to the rod, the control unit is moved another position where the handle is secured perpendicularly to the rod. The rod and the handle are able to be connected with different hand tools.

### BACKGROUND OF THE INVENTION

1. Fields of the Invention

The present invention relates to a hand tool assembly, and more particularly, to a hand tool assembly for being connected with driving tool or other hand tool.

2. Descriptions of Related Art

The conventional hand tool assembly is disclosed in U.S. Pat. No. 8,151,771 and comprises a first operation portion and a second operation which is pivotably connected to the first operation portion. The first operation portion has a stop, when the stop is located at the pressing portion and presses the first and second operation portions simultaneously, the first operation portion cannot pivoted relative to the second operation portion. A spring is located between the first operation portion and the stop so as to push a positioning member to contact the stop. However, when the stop moves, a significant friction is generated. Because the stop is pivotably connected to the first operation portion, when the user holds the stop and the first operation portion rotates 360 degrees, the first operation portion is suffered by a significant resistance because the stop has a positioning member and a pushing member received therein. The stop is positioned by the positioning member and the pushing member, the positioning member and the pushing member tend to be worn out after a period of use of the connection end. Besides, the inside wall of the notch is inclined relative to the inner periphery, and the positioning member can barely hold the stop, so that after a period of time of use, the positioning member is worn out and the stop could slip out from the first operation portion.

The present invention intends to provide a hand tool assembly to eliminate the shortcomings mentioned above.

### SUMMARY OF THE INVENTION

The present invention relates to a hand tool assembly and comprises a rod having a pivotal portion and a first connection end respectively formed on the front end and the rear end thereof. A transverse hole is defined transversely through the pivotal potion. Multiple dents are defined around the axis of the transverse hole. A first groove and a second groove are respectively defined in the outer periphery of the rod. A handle has a reception hole. A chamber is defined along the axis of the handle and located in the inner end of the reception hole. A first opening is defined in the first end of the handle and communicates with the reception hole. A second opening is defined radially in the handle and communicates with the reception hole. A pivotal hole is defined transversely through the middle portion of the handle and communicates with the reception hole. An outer portion is formed on the outside of the first end of the handle. A pin extends through the transverse hole and the pivotal hole to connect the rod and the handle.

A bead and a spring are located in the chamber, wherein the bead is biased by the spring so as to be engaged with one of the dents. A control unit has a base and a control member which is connected to the base. An engaging member is connected to the base. The control unit is rotatably mounted to the rod by the base and the control member.

When the control unit and the base are moved to a linear positioning position relative to the rod, and the control member moves to a pressing position relative to the base, the control member presses the engaging member into the first groove, and the rear end of the base contacts the outer portion to linearly secure the rod to the handle. When the control member moves to a releasing position relative to the base, the engaging member is released from the control member, and the control unit moves freely along the rod. When the control unit moves to a rotatable position relative to the rod, and the control member is located at the pressing portion relative to the base, the control member presses the engaging member into the second groove. The rear end of the base is separated from the outer portion so that the rod is rotatable relative to the handle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the hand tool assembly of the present invention;

FIG. 2 is a front view of the end piece of the hand tool assembly of the present invention;

FIG. 3 is a cross sectional view, taken along line A-A of FIG. 2;

FIG. 4 is a side view of the control member of the hand tool assembly of the present invention;

FIG. 5 shows the control unit of the hand tool assembly of the present invention;

FIG. 6 is a top view of the control unit of the hand tool assembly of the present invention;

FIG. 7 is a cross sectional view, taken along line B-B of FIG. 6;

FIG. 8 shows that the control unit presses the engaging member;

FIG. 9 shows that the handle is separated from the control unit;

FIG. 10 shows that the handle is adjusted to be a position perpendicular to the rod;

FIG. 11 is a cross sectional view, taken along line B-B of FIG. 10;

FIG. 12 shows that the handle is secured to a position perpendicular to the rod;

FIG. 13 is a cross sectional view, taken along line B-B of FIG. 12;

FIG. 14 shows the second embodiment of the rod of the control unit, and

FIG. 15 shows the third embodiment of the control unit.

### DETAILED DESCRIPTION OF THE PREFERRED EMBODIMENT

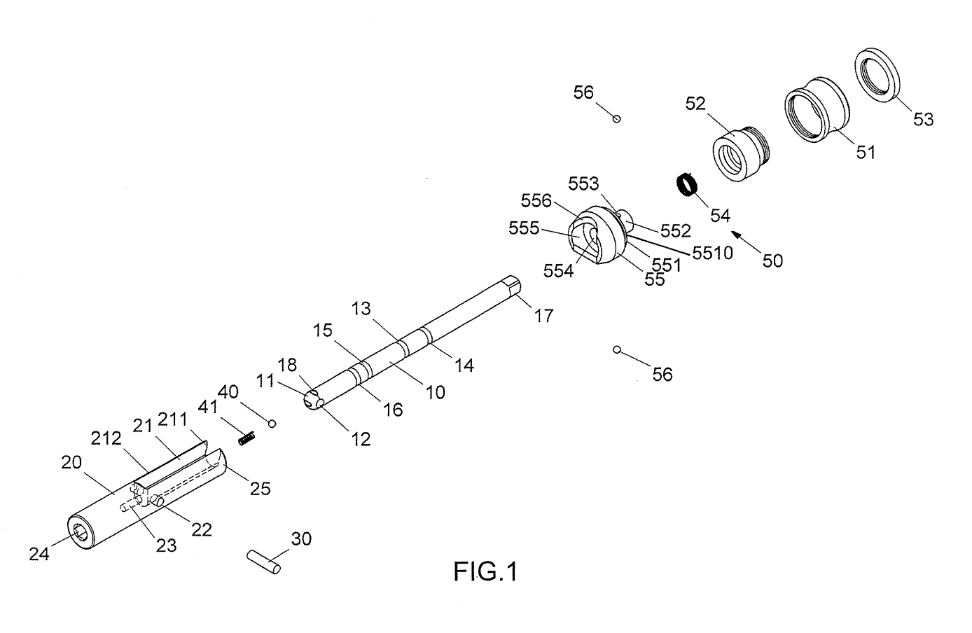

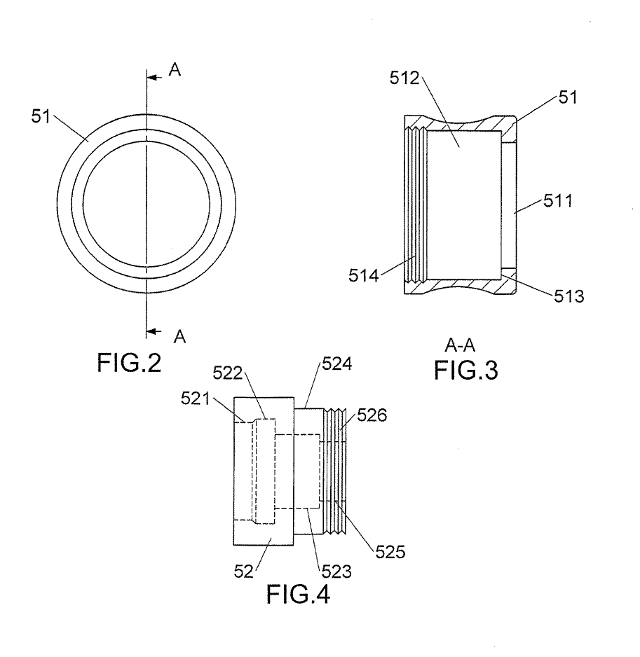

Referring to FIGS. 1 to 4, the hand tool assembly of the present invention comprises a rod 10, a handle 20 and a control unit 50. The rod 10 has a pivotal portion 11 and a first connection end 17 respectively formed on the front end and the rear end thereof. A transverse hole 12 are defined transversely through the pivotal potion 11. Two dents 18 are defined around the axis of the transverse hole 12 and located at a 90-degree from each other. A first groove 13, a second groove 14, a third groove 15 and a fourth groove 16 are respectively defined in the outer periphery of the rod 10. The first groove 13 is located closer to the pivotal portion 11 than the second groove 14. The third groove 15 is located closer to the pivotal portion 11 than the first and second grooves 13, 14. The fourth groove 16 is located closest to the pivotal portion 11.

The handle 20 has a reception hole 21 defined axially therein, and a chamber 23 is defined along the axis of the handle 20 and located in the inner end of the reception hole 21. The length of the reception hole 21 is one half of the length of the handle 20. A first opening 211 is defined in the first end of the handle 20 and communicates with the reception hole 21. A second opening 212 is defined radially in the handle 20 and communicates with the reception hole 21. A pivotal hole 22 is defined transversely through the middle portion of the handle 20 and communicates with the reception hole 21. An outer portion 25 is formed on the outside of the first end of the handle 20. A second connection end 24 is formed on the rear end of the handle 20 and is one of a rectangular recess and a hexagonal recess. A pin 30 extends through the transverse hole 12 and the pivotal hole 22 to connect the rod 10 and the handle 20 so that the handle 20 and the rod 10 can be arranged to be a linear arrangement or to be a T-shaped arrangement. A bead 40 and a spring 41 are located in the chamber 23, the bead 40 is biased by the spring 41 so as to be engaged with one of the dents 18.

The control unit 50 has a base 55 and a control member 52 which is connected to the base 55. Two engaging members 56 are connected to the base 55. The control unit 50 is rotatably mounted to the rod 10 by the base 55 and the control member 52. The engaging members 56 perform as a bearing. When the control unit 50 and the base 55 are moved to a linear positioning position relative to the rod 10, and the control member 52 moves to a pressing position relative to the base 55, the control member 52 presses the engaging members 56 into the first groove 13. The rear end of the base 55 contacts the outer portion 25 to linearly secure the rod 10 to the handle 20. When pushing the collar 53, the control member 52 moves to a releasing position relative to the base 55, the two engaging members 56 are released from the control member 52, the control unit 50 moves freely along the rod 10, when the control unit 50 moves to a rotatable position relative to the rod 10, and the control member 52 is located at the pressing portion relative to the base 55, the control member 52 presses the engaging member 56 into the second groove 14. The rear end of the base 55 is separated from the outer portion 25 so that the rod 10 is rotatable relative to the handle 20 to form a T-shaped arrangement. The base 50 has a through hole 554 defined axially therethrough and the rod 10 extends through the through hole 554. The front end 551 of the base 55 has outer threads 5510 which are threadedly connected to the inner threads 514 of an end piece 51. A tubular portion 552 extends from the center of the front end of the base 55 and two bead holes 553 are defined in the outer periphery of the tubular portion 552. Each bead hole 553 receives a spherical engaging member 56 therein. A recessed area 555 is defined in the rear end of the base 55 and communicates with the through hole 554 which shares a common axis with the recessed area 555. The tubular portion 552 of the base 55 rotatably extends through the third circular recess 523. Each bead hole 553 is a cone-shaped hole and expands outward, each bead hole 553 communicates with the through hole 554. The diameter of the engaging member 56 is larger than the minimum diameter of the bead hole 553 corresponding thereto. The outer portion 25 of the handle 20 is received in the recessed area 555. The inner diameter of the recessed area 555 is matched with the outer diameter of the outer portion 25.

The end piece 51 has a circular room 512 defined axially therethrough which has inner threads 514 defined in the rear end thereof. A flange extends inward from the front end of the end piece 51 and a protruding stop 513 is formed in the inside of the flange. A circular hole 511 is defined in the inner periphery of the flange. The control member 52 is movably received in the circular room 512. The control member 52 has a first circular recess 521, a second circular recess 522, a third circular recess 523 and a fourth circular recess 525 defined in sequence from the rear end of the control member 52. The first, second, third and fourth circular recess 521, 522, 523, 525 communicate with each other. The diameter of the first circular recess 521 is smaller than that of the second circular recess 522. The diameter of the third circular recess 523 is smaller than that of the first circular recess 521. A tubular portion 524 extends from the front end of the control member 52 and is rotatably extends through the circular hole 511. The diameter of the fourth circular recess 525 is smaller than that of the third circular recess 523. The inner diameter of the fourth circular recess 525 is matched with the outer diameter of the rod 10. The tubular portion 524 has outer threads 526 defined in the outer periphery of one end thereof. The outer threads 526 of the control member 52 protrude beyond the end piece 51.

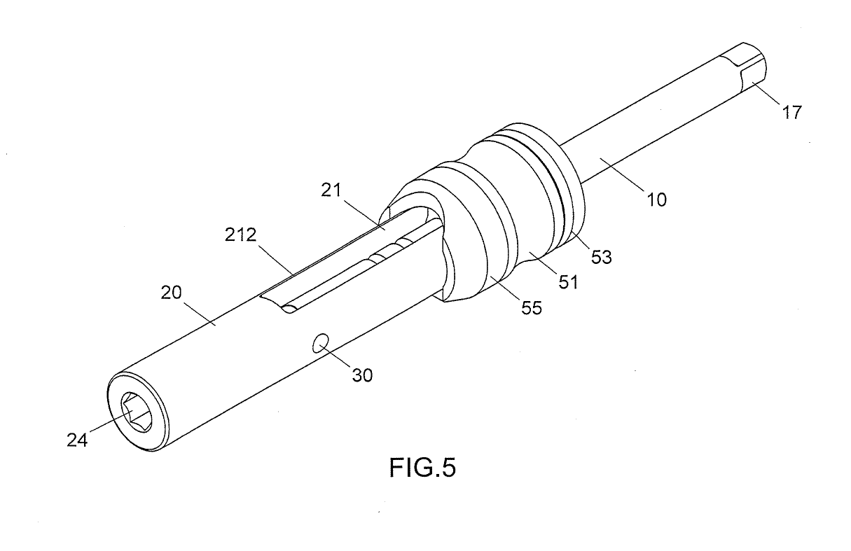

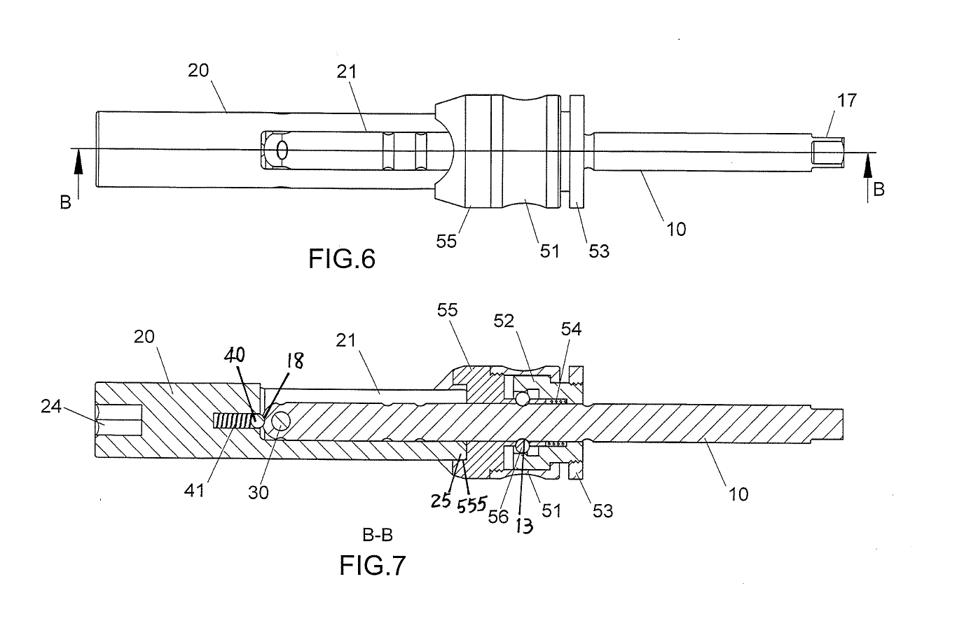

Further referring to FIGS. 5 to 7, a collar 53 is threadedly connected to the outer threads 526 of the tubular portion 524 of the control member 52. A gap is formed between the collar 53 and the end piece 51. The spring 54 is located in the third circular recess 523 and biased between the control member 52 and the tubular portion 552 so as to push the control member 52 to contact the stop 513.

The recessed area 555 has two opposite insides and each of the two opposite insides has a notch 556 defined in the distal end thereof, so that the handle 20 is engaged with the notches 556. The inner diameter of the recessed area 555 is matched with the outer diameter of the handle 20.

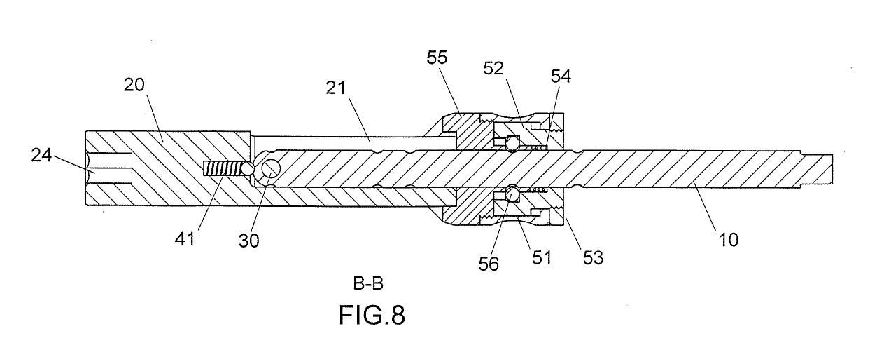

As shown in FIG. 8, when pressing the collar 53, the control member 52 moves to a releasing position relative to the base 55, and presses the spring 54, the second circular recess 522 is located corresponding to the first groove 13. The engaging members 56 are not pressed by the control member 52 such that the control unit 50 is freely moved along the rod 10.

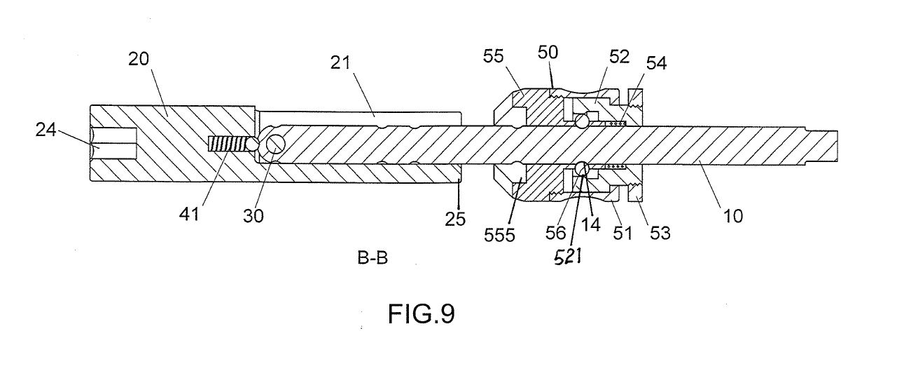

As shown in FIG. 9, when the control unit 50 moves to a position where the user releases the control member 52, the spring 54 pushes the control member 52 back to the pressing position, so that the engaging members 56 are pushed by the control member 52 and engaged with the second groove 14. The outer portion 25 is separated from the recessed area 555, the rod 10 is freely rotated about the pin 30 relative to the handle 20.

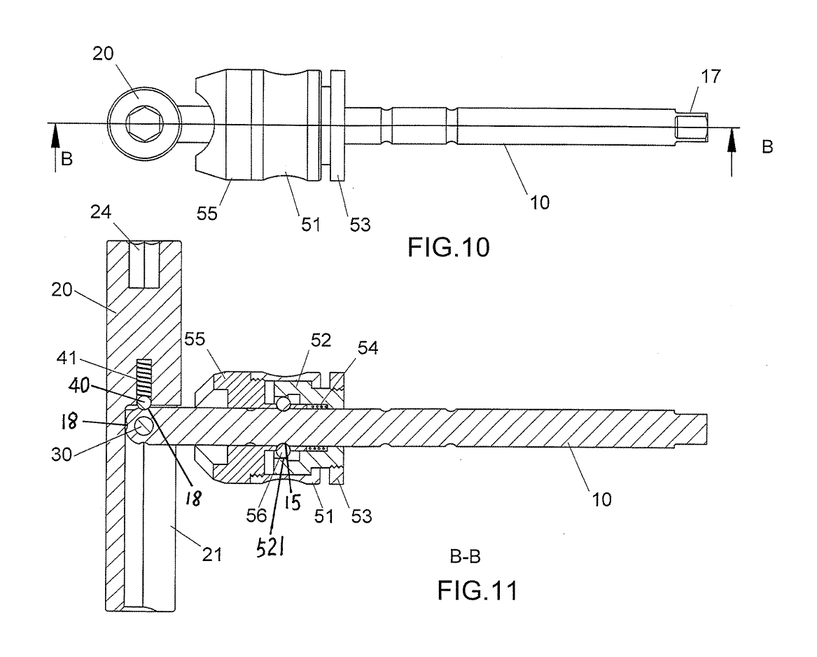

As shown in FIGS. 10 and 11, the handle 20 is rotated about the pin 30 and is located at a position where the handle 20 is located perpendicular to the rod 10 to form a T-shaped arrangement. The control unit 50 moves to an angle-restricted position relative to the rod 10. The engaging members 56 are engaged with the third groove 15. The rod 10 is restricted by the control unit 50 and movable within a scope less than 90 degrees relative to the handle 10.

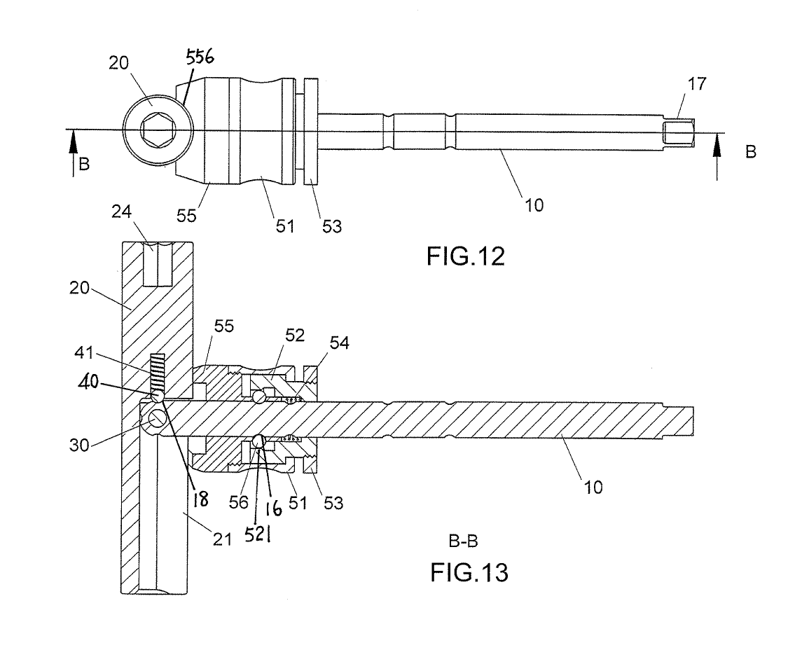

As shown in FIGS. 12 and 13, when the control unit 50 moves to a position that the control unit 50 is perpendicular to the rod 10, the engaging members 56 are pushed by the control member 52 and engaged with the fourth groove 16. The handle 20 is engaged with the notches 556, the handle 20 and the rod 10 are perpendicularly positioned by the control unit 50.

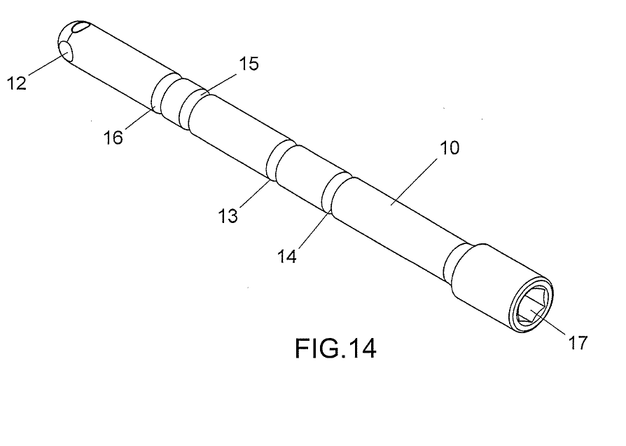

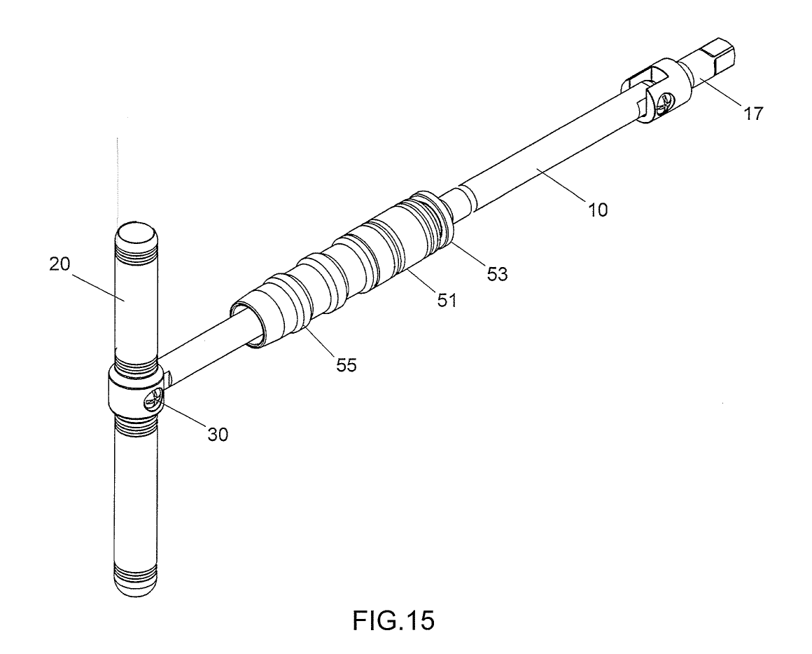

As shown in FIG. 14, the first connection end 17 of the rod 10 is a hexagonal recess. As shown in FIG. 15, the first connection end 17 of the rod 10 is pivotably connected to the rod 10.

While we have shown and described the embodiment in accordance with the present invention, it should be clear to those skilled in the art that further embodiments may be made without departing from the scope of the present invention.

What is claimed is:

1. A hand tool assembly comprising:
a rod having a pivotal portion and a first connection end respectively formed on a front end and a rear end thereof, a transverse hole defined transversely through the pivotal potion, multiple dents defined around an axis of the transverse hole, a first groove and a second groove respectively defined in an outer periphery of the rod, the first groove being located closer to the pivotal portion than the second groove;
a handle having a reception hole defined axially therein, a chamber defined along an axis of the handle and located in an inner end of the reception hole, a first opening defined in a first end of the handle and communicating with the reception hole, a second opening defined radially in the handle and communicating with the reception hole, a pivotal hole defined transversely through a middle portion of the handle and communicating with the reception hole, an outer portion formed on an outside of the first end of the handle;
a pin extending through the transverse hole and the pivotal hole to connect the rod and the handle;
a bead and a spring located in the chamber, the bead being biased by the spring so as to be engaged with one of the dents, and
a control unit having a base and a control member which is connected to the base, at least one engaging member connected to the base, the control unit rotatably mounted to the rod by the base and the control member, when the control unit and the base are moved to a linear positioning position relative to the rod, and the control member moves to a pressing position relative to the base, the control member presses the at least one engaging member into the first groove, a rear end of the base contacts the outer portion to linearly secure the rod to the handle, when the control member moves to a releasing position relative to the base, the at least one engaging member is released from the control member, the control unit moves freely along the rod, when the control unit moves to a rotatable position relative to the rod, and the control member is located at the pressing portion relative to the base, the control member presses the engaging member into the second groove, the rear end of the base is separated from the outer portion so that the rod is rotatable relative to the handle.

2. The hand tool assembly as claimed in claim 1, wherein the base has a through hole defined axially therethrough, the rod extends through the through hole, a front end of the base is threadedly connected to an end piece, a tubular portion extends from a center of the front end of the base and two bead holes are defined in an outer periphery of the tubular portion, each bead hole receives a spherical engaging member therein, a recessed area is defined in the rear end of the base and communicates with the through hole which shares a common axis with the recessed area, the outer portion of the handle is received in the recessed area, the end piece has a circular room defined axially therethrough which has inner threads defined in a rear end thereof, a flange extends inward from a front end of the end piece and a stop is formed in an inside of the flange, a circular hole is defined in an inner periphery of the flange, the control member is movably received in the circular room, the control member has a first circular recess, a second circular recess, a third circular recess and a fourth circular recess defined in sequence from a rear end of the control member, the first, second, third and fourth circular recess communicate with each other, a diameter of the first circular recess is smaller than that of the second circular recess, a diameter of the third circular recess is smaller than that of the first circular recess, a tubular portion extends from a front end of the control member and is rotatably extends through the circular hole, a diameter of the fourth circular recess is smaller than that of the third circular recess, an inner diameter of the fourth circular recess is matched with an outer diameter of the rod, the tubular portion has outer threads defined in an outer periphery of an end thereof, the outer threads of the control member protrude beyond the end piece, a collar is threadedly connected to the outer threads of the tubular portion of the control member, a gap is formed between the collar and the end piece, the spring is located in the third circular recess and biased between the control member and the tubular portion so as to push the control member to contact the stop, the front end of the base has outer threads which are threadedly connected to the inner threads of the end piece, the tubular portion of the base rotatably extends through the third circular recess, each bead hole is a cone-shaped hole and expands outward, each bead hole communicates with the through hole, a diameter of the engaging member is larger than a minimum diameter of the bead hole corresponding thereto.

3. The hand tool assembly as claimed in claim 2, wherein an inner diameter of the recessed area is matched with an outer diameter of the outer portion.

4. The hand tool assembly as claimed in claim 2, wherein the recessed area has two opposite insides and each of the two opposite insides has a notch defined in a distal end thereof, the handle is engaged with the notches.

5. The hand tool assembly as claimed in claim 4, wherein an inner diameter of the recessed area is matched with an outer diameter of the handle.

6. The hand tool assembly as claimed in claim 1, wherein the rod has a third groove defined in the outer periphery thereof, the third groove is located closer to the pivotal portion than the first and second grooves, when the handle is rotated 90 degrees relative to the rod, and the control unit moves to an angle-restricted position relative to the rod, the engaging member is engaged with the third groove, the rod is restricted by the control unit and movable within a scope less than 90 degrees relative to the handle.

7. The hand tool assembly as claimed in claim 1, wherein the rod has a fourth groove defined in the outer periphery thereof, the fourth groove is located closer to the pivotal portion than the first and second grooves, the rear end of the base has a recessed area which communicates with the through hole which shares a common axis with the recessed area, the outer portion of the handle is received in the recessed area, the recessed area has two opposite insides and each of the two opposite insides has a notch defined in a distal end thereof, when the control unit moves to a position that the control unit is perpendicular to the rod, the engaging member is pushed by the control member and engaged with the fourth groove, the handle is engaged with the notches, the handle and the rod are perpendicularly positioned by the control unit.

8. The hand tool assembly as claimed in claim 1, wherein the first connection end is one of a rectangular head, a hexagonal head, a hexagonal recess, an open end and a closed end.

9. The hand tool assembly as claimed in claim 1, wherein the second connection end is one of a rectangular recess and a hexagonal recess.

10. The hand tool assembly as claimed in claim 1, wherein the first connection end is pivotably connected to the rod.

11. The hand tool assembly as claimed in claim 1, wherein a length of the reception hole is one half of a length of the handle.
